(19) United States
(12) Patent Application Publication
(10) Pub. No.: US 2014/0026037 A1
(43) Pub. Date: Jan. 23, 2014

(54) CREATING PERSONALIZED NETWORKED DOCUMENTS

(71) Applicants: Rachel Garb, Mountain View, CA (US); Lawrence Wen-Kai Shih, Mountain View, CA (US); Ryohei Takahashi, Mountain View, CA (US)

(72) Inventors: Rachel Garb, Mountain View, CA (US); Lawrence Wen-Kai Shih, Mountain View, CA (US); Ryohei Takahashi, Mountain View, CA (US)

(73) Assignee: GOOGLE INC., Mountain View, CA (US)

(21) Appl. No.: 12/033,532

(22) Filed: Feb. 19, 2008

(51) Int. Cl. G06F 17/00

(52) U.S. Cl. 715/235; 715/234; 715/255

(57) ABSTRACT

Techniques are described for creating personalized networked documents. A user request to create a web page element associated with the user and an indication of a topic to which content of the web page element is to relate is received. Content to be added to the web page element is automatically identified based on popularity of content related to the topic according to other users who share a demographic characteristic with the user. The web page element having the identified content is created.

### TECHNICAL FIELD

This disclosure is generally related to personalized networked documents.

### BACKGROUND

The world wide web (or web) is a portion of the Internet that allows a computer system to access electronic documents which are stored on another computer system. The electronic documents may be referred to as electronic pages, web pages or, more simply, pages. A web page may include text, graphics, sounds other types of multimedia information, data fields, and links, called hyperlinks, to files and documents accessible on other web pages. A collection of web pages hosted by an entity may be referred to as a web site. A user of a computer system can access and display web pages from web sites using a graphical user interface (GUI) generated by a browser application executing on the user's computer. A browser application also may be referred to as a web browser or simply, a browser. Web browsers may use a variety of protocols for accessing and communicating with web sites. One example of such a protocol is the HyperText Transfer Protocol (HTTP).

Web pages may be created by an individual to include content related to the individual. Such a web page may be referred to, for example, as a personalized web page, a personal web page, a personalized web page, a customized web page or a personal home page. A personalized web page may include content about which the individual is interested.

### SUMMARY

In one general aspect, a user request to create a web page element associated with the user and an indication of a topic to which content of the web page element is to relate is received. Content to be added to the web page element is automatically identified based on popularity of content related to the topic according to other users who share a demographic characteristic with the user. The web page element having the identified content is created.

Implementations may include one or more of the following features. For example, automatically identifying content to be added may include accessing popularity indications of content, where the popularity indications are stored in a computer storage medium and indicate popularity of content related to topics. The accessed popularity indications may be used to identify popular content that is related to the topic of the web page element to be created, where the determination is based on popularity of content according to other users who share a demographic characteristic with the user. Automatically identifying content to be added may include identifying content to be added to the web page element based on the indicated topic, a demographic of the user and accessed popularity indications of content. Automatically identifying content to be added may include automatically identifying, without human intervention, content to be added to the web page element based on popularity of content related to the topic according to other users who share a demographic characteristic with the user.

Receiving an indication may include receiving an indication of the topic based on a name of a control used to navigate to the created web page element. The demographic characteristic may include one of a country or language. The identified content may include automatically updated content, which may include a RSS feed. The identified content may include a gadget. The popularity of the content may represent content that is the most frequently occurring content.

A theme for the web page element may be automatically selected based on popularity of a theme according to other users who share the demographic characteristic with the user. A layout style for the web page element may be automatically selected based on popularity of a layout style for a personalized web page element. A recommendation may be automatically provided to the user of new content for the web page element based on popularity of content related to the topic according to other users who share a second demographic characteristic with the user.

In another general aspect, content to be added to an electronic document created for a particular user and made accessible to the particular user over a network is automatically identified. The content is identified based on popularity of content related to a topic according to other users who share a characteristic with the particular user. The electronic document having the identified content is created. The electronic document is made accessible over the network to the particular user. Implementations may include one or more of the features noted above.

Implementations of the techniques discussed above may include a method or process, a system or apparatus, or computer software on a computer-accessible medium. The details of one or more implementations are set forth in the accompanying drawings and the description below. Other features and advantages will be apparent from the description and drawings as well as from the claims.

### BRIEF DESCRIPTION OF THE DRAWINGS

FIG. 1 is a block diagram depicting an example environment capable of providing personalized web pages.

FIGS. 2A-2D illustrate example user interfaces for providing personalized web pages.

FIG. 3 is a flow chart of an example process for creating a personalized web page.

FIG. 4 illustrates an example environment configured to provide personalized web pages.

FIG. 5 shows an example process for identifying popular content.

FIGS. 6A and 6B illustrate example user interfaces for applying a theme to a personalized web page.

FIG. 7 illustrates an example web page for selecting content for a personalized web page from a directory.

FIG. 8 is a block diagram illustrating an example computer system capable of providing personalized web pages.

Like reference symbols in the various drawings indicate like elements.

### DETAILED DESCRIPTION

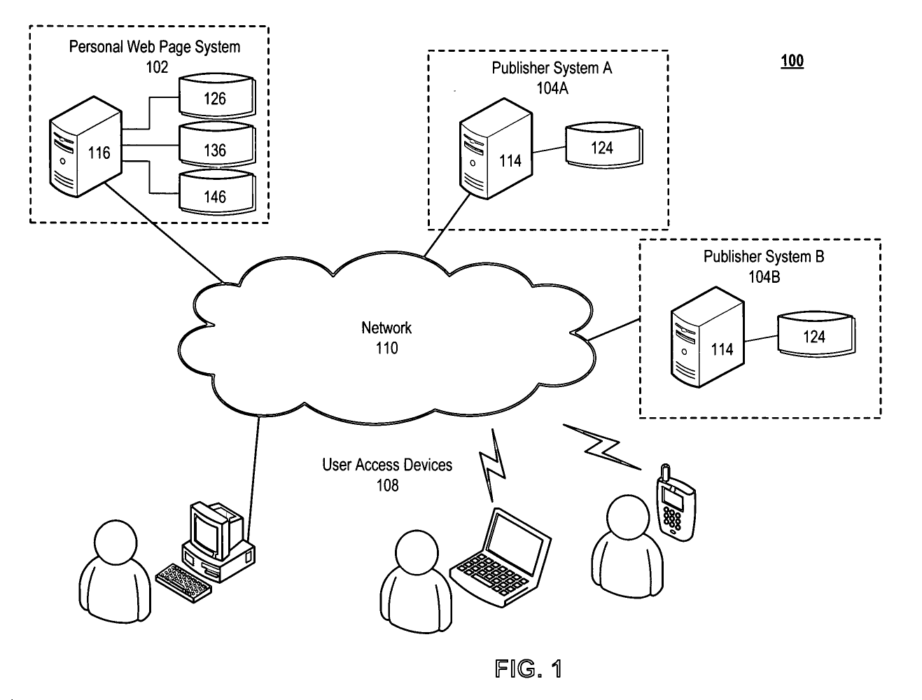

FIG. 1 is a block diagram depicting an example environment 100 capable of providing personalized web pages. The environment 100 includes a personalized web page system 102, publisher systems 104A and 104B (hereinafter referred to as the publisher 104A and publisher 104B, respectively), and one or more user access devices 108, which may be communicatively coupled to a network 110. The personalized web page system 102 may be a search provider. An example of a personalized web page system is iGoogle offered by Google™ Inc. of Mountain View, Calif.

The personalized web page system 102 is configured to create personalized web pages for users. Selecting content for a personalized web page may be difficult for a user due to the large amount of content choices available. The personalized web page system 102 can help with content selection by automatically selecting popular content for a user's personalized web page based on user-specified topics.

The personalized web page system 102 is configured to receive a user request (e.g., from a user access device 108) to create a web page associated with the user. The user request indicates a topic to which content of the web page is to relate. For example, in some implementations, the user request may include a name for a tab to be used to navigate to a web page on which the content is to be rendered. Additionally or alternatively, a tab name may indicate a topic for which content is to be rendered.

The personalized web page system 102 is configured to automatically without human intervention identify content to be added to a user's personalized web page based on popularity of content related to the topic. More particularly, the personalized web page system 102 is configured to identify the most frequently occurring content related to the topic according to the frequency of use by other users. For example, the personalized web page system 102 may be configured to identify content based on the most frequently occurring content on other user's personalized web pages. In some examples, the personalized web page system 102 may be configured to identify content according to other users who share demographic characteristics (e.g., country, region, language, personal interests, occupation, etc.) with the user. Indications of content popularity can be stored in a popularity database 126, which is included in, or accessible to, the personalized web page system 102. The personalized web page system 102 is configured to access the popularity database 126 to determine the most popular content related to a topic.

The publishers 104A and 104B are configured to provide content. For example, the publisher 104A may be configured to provide sports content and the publisher 104B may be configured to provide news content. Although only two publishers are shown in FIG. 1, it should be understood that any number of publishers may be included in the environment 100 and the publisher need not necessarily be limited to providing content related only to a single topic.

The publishers 104A and 104B are configured to provide content using what may be referred to as a “gadget”. A gadget is an item of content that can be presented in a web page. A gadget can be implemented using HTML (HyperText Markup Language), XML (eXentisible Markup Language), JavaScript, Java, Flash™, RSS (Really Simple Syndication) feeds, CSS (Cascading Style Sheets) and other technologies. Example gadgets include a stock market ticker that displays stock prices, a news gadget that displays news headlines, and a sports gadget that displays sports scores. The personalized web page system 102 is configured to create a web page which includes gadgets associated with the publishers 104A and 104B.

The personalized web page system 102 includes a gadget database 136. The gadget database 136 includes information related to gadgets that can be displayed on a personalized web page. The gadget database 136 may include, for each gadget, a name which may be displayed as a title when the gadget is presented on a web page. The gadget database 136 may also include location information for a gadget, such as a web address or URL (Uniform Resource Locator). Gadgets may be associated with a topic (e.g., category, subject area, etc.). For example, a stock ticker gadget may be associated with a finance topic.

The personalized web page system 102 includes a user database 146. The user database 146 includes information associated with users who create personalized web pages using the personalized web page system 102. For example, the user database 146 may include user account information, such as user identifiers (IDs) and passwords. The user database 146 also includes information about personalized web pages created by users, such as, for each user, names of created pages (which, in some implementations, may correspond to navigation tab names) and references to content to be displayed on each page. In some implementations, content references refer to gadgets in the gadget database 136.

In some examples, each of the elements 102, 104A-B, 108 and 110 may be implemented or associated with hardware components, software components, or firmware components or any combination of such components. The elements 102, 104A-B, 108 and 110 could, for example, be implemented or associated with general purpose servers, software processes and engines, and/or various embedded systems. For example, the personalized web page system 102 may include one or more data processing systems, such as servers (e.g., server 116) or embedded systems, coupled to the network 110. The personalized web page system 102 may include or maintain one or more processes that run on one or more data processing systems. As another example, each of the publishers 104A and 104B may include or maintain one or more processes that run on one or more data processing systems (e.g., servers or embedded systems). For example, each of the retailers 104A and 104B includes a data processing system 114, coupled to the network 110. In some examples, a publisher may include one or more repositories 124 for storing content information.

The user access devices 108 could include general computing components and/or embedded systems optimized with specific components for performing specific tasks. Examples of user systems include personal computers (e.g., desktop computers), mobile computing devices, mobile phones, smart phones, media players, media players/recorders, music players, game consoles, mobile game devices, media centers, electronic tablets, electronic book readers, personal digital assistants (PDAs), mobile electronic messaging devices, television systems, audio systems, removable storage devices, navigation systems and the like.

The network 110 may include any element or system that facilitates communications among and between various network nodes, such as elements 108, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 could include any number of geographically-dispersed publisher 104A-B and/or user access devices 108, which may be discrete, integrated modules or distributed systems. Similarly, the environment 100 is not limited to a single personalized web page system 102 and may include any number of integrated or distributed personalized web page system elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a process or processes running on a single machine.

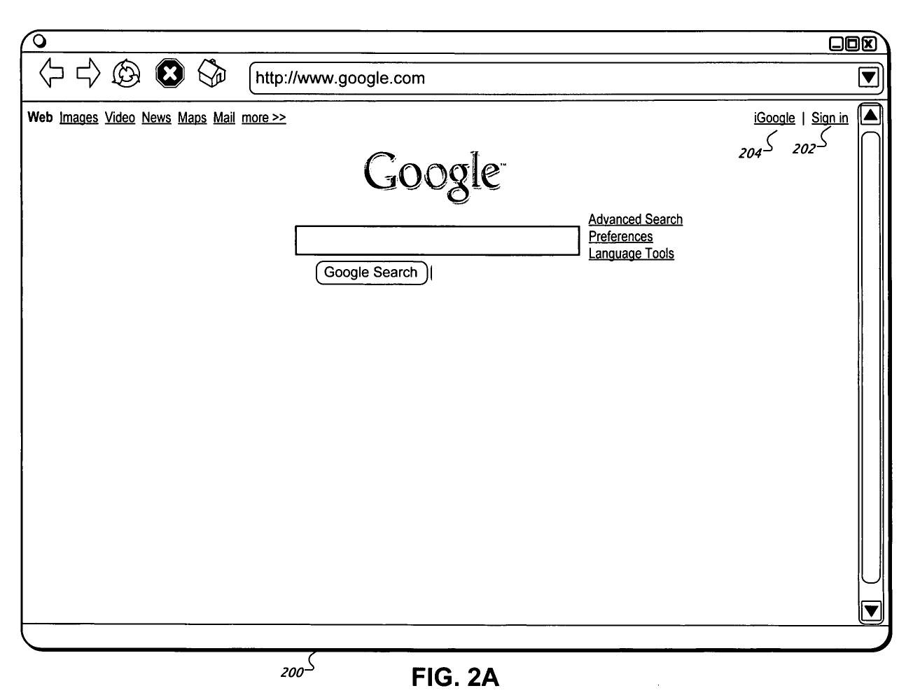

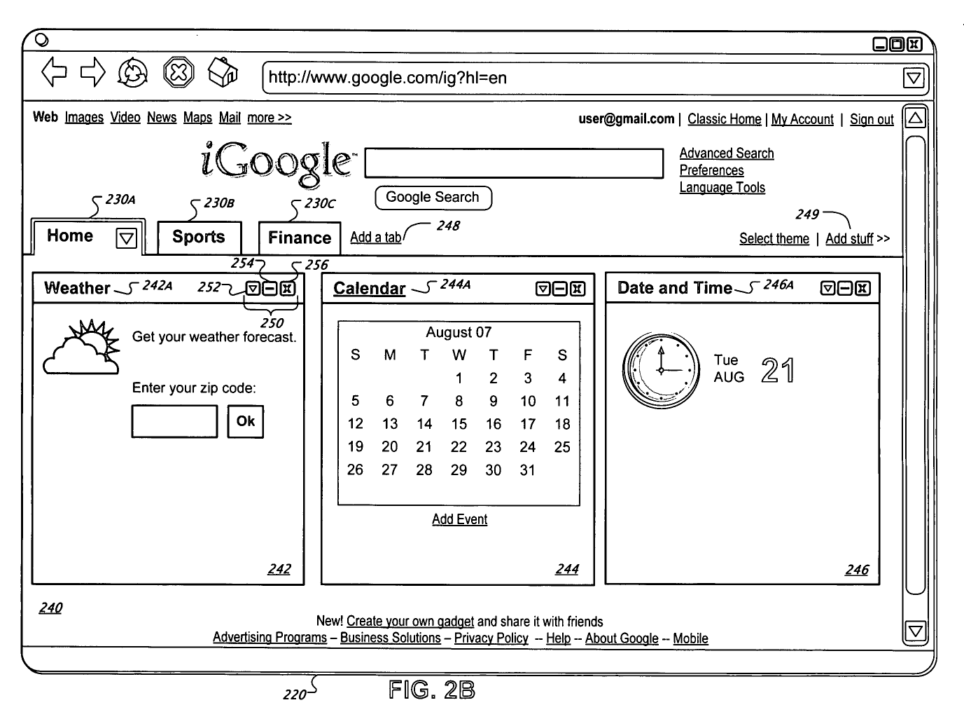

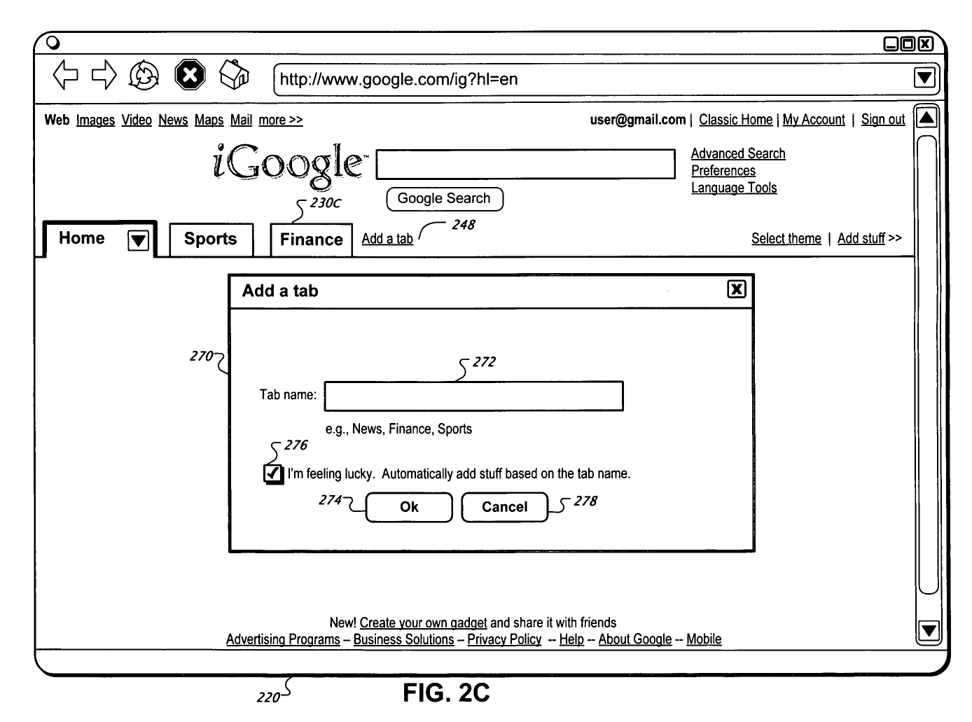

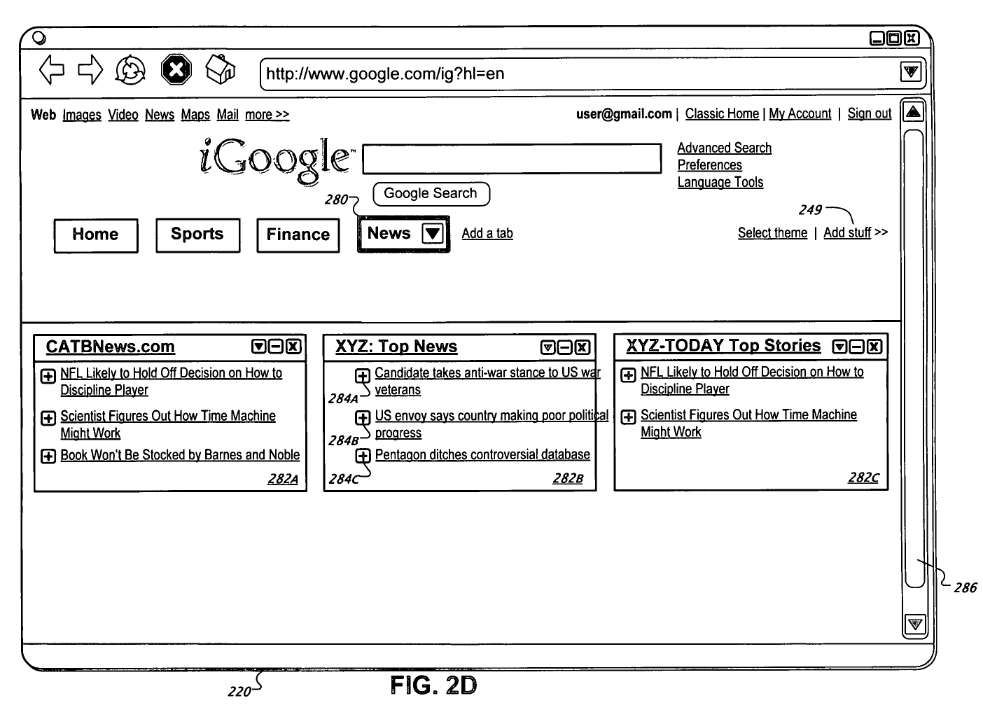

FIGS. 2A-2D illustrate example user interfaces for providing personalized web pages. Referring to FIG. 2A, a web page 200 for a search service provided by a search provider also provides a personalized web page system. In the example of FIG. 2A, the search provider the web page 200, which may be referred to a “home page” or as a “portal” (e.g., as a starting point for web browsing) and which may be customized to provide a personalized web page.

As illustrated, the web page 200 includes a “sign in” link 202, which may be used to log in to the personalized web page system 102. Once logged in, a user may switch to a personalized web page by selecting a link 204. Alternatively, a user may select a personalized web page as a default portal or home page presented by the search provider.

FIG. 2B illustrates an example personalized web page 220 that includes a set of navigation tabs 230A-230C. The user can select one of tabs 230A-230C and content associated with the selected tab is displayed in an area 240 of the personalized web page 220. Here, the tab 230A (e.g., the “Home” tab) is selected. The text on each of the tabs indicates the topic to which displayed content relates.

A user can add tabs by selecting a link 248. When adding a tab, the user specifies a tab name (e.g., “Finance”). In response, the personalized web page system 102 creates a web page that is to be displayed when a tab is selected. For example, the personalized web page system 102 automatically identifies content to include on the displayed web page. The personalized web page system 102 accesses the popularity database 126 to identify the most popular content associated with the tab name. The user can browse for and add content to their personalized web page by selecting a link 249.

The area 240 presents content associated with the selected tab using a set of gadgets. Here, a weather forecast gadget 242, a calendar gadget 244, and a date and time gadget 246 are displayed. Gadgets may include a title. For example, the gadget 242 includes a “Weather” title 242A, the gadget 244 includes a “Calendar” title 244A, and the gadget 246 includes a “Date and Time” title 246A. In some implementations, the personalized web page system 102 may identify an initial group of gadgets to display on the home tab 230A as a default set of gadgets to be displayed while the “Home” tab 230A is selected. A user may change the default set of gadgets.

The user configures a gadget using a set of control buttons 250. The control buttons 250 include a settings button 252, a collapse/expand button 254, and a close button 256. The user can adjust settings for a gadget using the settings button 252. For example, for the gadget 242, the user can change a zip code associated with the weather forecast displayed in the weather forecast gadget 242. As another example, the user can change a time zone associated with the date and time gadget 246. For gadgets that include text, the user can, for example, change text-related settings, such as configuring the number of lines of text displayed by the gadget.

The user can select the collapse/expand button 254 to alternatively collapse and expand a gadget. A collapsed gadget is shown in a minimized state, with the title bar (and no content) displayed. The user can select the collapse/expand button 254 on a minimized gadget to expand the gadget back to its original size. The user can move and rearrange gadgets by selecting a gadget title and dragging and dropping the gadget to a new location within the area 240. The user can remove a gadget by selecting the close button 256.

FIG. 2C illustrates the personalized web page 220 having an example user interface 270 for adding content to a personalized web page. In this example, the interface 270 is a pop-up window that is displayed over the web page 220, for example, in response to a user selecting the link 248. The interface 270 includes a text field 272 which accepts a user-entered tab name (e.g., the user may type one or more words). Other user interface elements can be used to indicate a tab name. For example, the user can select a tab name from a list of popular tab names presented in a list box. If the user selects an “Ok” button 274, a new tab is created having the specified tab name. The new tab is to be displayed on the personalized web page 220, for example, in the rightmost position (e.g., a newly-added tab could be added to the right of the tab 230C).

If the user selects a checkbox 276 on the interface 270 and then subsequently selects the “Ok” button 274, the tab is created for the personalized web page 220 to display automatically identified content associated with the name of the tab. For example, if a user enters a tab name of “news,” a tab is created and when selected, presents automatically identified news content based on popular content for the topic. As another example, if a user enters a tab name of “sports,” a new tab is created to present automatically identified sports content. If the user selects a “Cancel” button 278, a new tab is not created and the user interface 270 is removed from the display. In some implementations, the name of the tab is a surrogate for, or otherwise indicates, the topic for which content is automatically identified for a personalized web page. As described below, in some implementations, the content added under the new tab include gadgets relating to the tab name.

FIG. 2D illustrates the personalized web page 220 presenting newly added content. The personalized web page 220 is shown with a new tab 280 named “News,” as described with regard to FIG. 2C. The tab 280 is created, for example, in response to the user entering a tab name of “News” in the text field 272 and clicking the “Ok” button 274, such as by using the interface 270 with respect to FIG. 2C. The personalized web page system 102 creates the tab 280 and may automatically identify popular content associated with the tab name (e.g., “News”) for display on the personalized web page 220 when tab 280 is selected by a user. In some implementations, the new tab is displayed as the selected tab after the tab is created.

Identified content is presented using gadgets. The tab 280 displays a set of gadgets 282A-282C. The gadgets 282A-282C may be provided by one or more publishers (e.g., publishers 104A-B). Each of the gadgets 282A-282C includes a set of news headline links. For example, the gadget 282B includes three news headline links 284A-284C. The user can select one or more of the news headline links 284A-284C to see more detailed news content related to the displayed headlines. A scroll bar 286 may be selected to scroll to additional gadgets not current visible on the tab 280.

In some implementations, the content identified automatically without human intervention based on popularity of content appearing on personalized web pages of users that share a demographic or another type of characteristic with the user for whom the content is identified is default content that may be changed (such as by adding or removing gadgets).

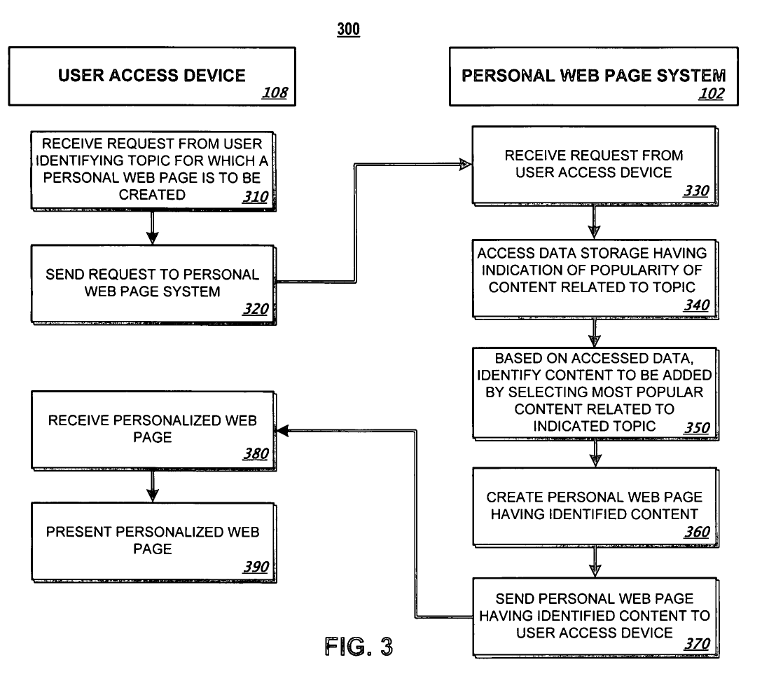

FIG. 3 is a flow chart of an example process 300 for creating a personalized web page. The process 300 may be performed, for example, using a user access device 108 and the personalized web page system 102, both as described previously with respect to FIG. 1.

The process 300 includes receiving a request from a user identifying a topic for which a personalized web page is to be created (310). This may be performed, for example, by a user using a user access device 108. The user may identify a topic, for example, using the interface 270, as discussed previously with respect to FIG. 2C. The user may enter a topic name by typing one or more words, or the user may select a topic name from a list of presented topic names (e.g., a list of popular topic names may be presented in the interface 270 in a list box). As another example, the user may select a topic from a menu of the most popular topics. A user can indicate that the topic is a “home” topic, indicating that the page to be created is the user's home page.

Once an indicated topic name is received, a request is sent to the personalized web page system (320). For example, the user access device 108 can send an HTTP (HyperText Transfer Protocol) request, including the indicated topic name, to the personalized web page system 102 across the network 110 (the network 110 was described previously with respect to FIG. 1), to request creation of a personalized web page related to the requested topic. A user identity (e.g., user login information) may be included in the request.

The request is received from the user access device (330). For example, the personalized web page system 102 may receive an HTTP request, including the indicated topic name, from the user access device 108, across the network 110.

Once the request has been received, data storage having indications of popularity of content related to the topic is accessed (340). For example, the personalized web page system 102 can access the popularity database 126 (described previously with respect to FIG. 1). The popularity database 126 may store a frequency of occurrence of content items, indicating how often content items appear in users' personalized web pages.

Based on accessed data, content to be added is identified by selecting the most popular content related to the indicated topic (350). For example, the personalized web page system 102 identifies the most popular content in the popularity database 126 related to the indicated topic. In some implementations, related content may be selected based on a frequency threshold. For example, content may be selected based on a relevance to the indicated topic and also based on whether a content item appears in at least a certain number (e.g., 1000) of personalized web pages. Identified content can be filtered based on user demographics. For example, identified content can match the user's geographical region, country, language and/or other types of demographic or user characteristic information.

Once content has been identified, a personalized web page having the identified content is created (360). For example, the personalized web page system 102 can create a web page document which includes the identified content. Identified content can be displayed in the created web page document using one or more gadgets, though this need not necessarily be so. Gadgets may be retrieved from the gadget database 136 discussed previously with respect to FIG. 1. In some implementations, gadgets are organized under a tab having the user-specified name.

The created web page is saved in association with the user, for example, in the user database 146. In some implementations, the contents of the web page do not change once the page is created unless the user manually changes the contents. In other implementations, the personalized web page system 102 periodically recommends new content, which the user can choose to add to the page. Additionally or alternatively, the personalized web page system 102 may automatically replace content that was previously automatically identified (as opposed to content manually added or selected by the user).

Once the web page has been created, the personalized web page having the identified content is sent to the user access device (370). For example, the personalized web page system 102 sends the created web page to the user access device 108, across the network 110 (e.g., using HTTP).

A personalized web page is received (380). For example, a personalized web page document sent by the personalized web page system 102 across the network 110 (370) may be received by a user access device 108. The user access device 108 stores the received web page in memory and/or in persistent storage.

The personalized web page is presented (390). For example, the personalized web page may be presented in a web browser running on the user access device 108. The personalized web page may be displayed as a “tab.” such as the tab 280 as discussed previously with respect to FIG. 2D. The displayed tab may be named using the indicated topic name (e.g., a tab with a name of “News” may be created if the indicated topic is “news”).

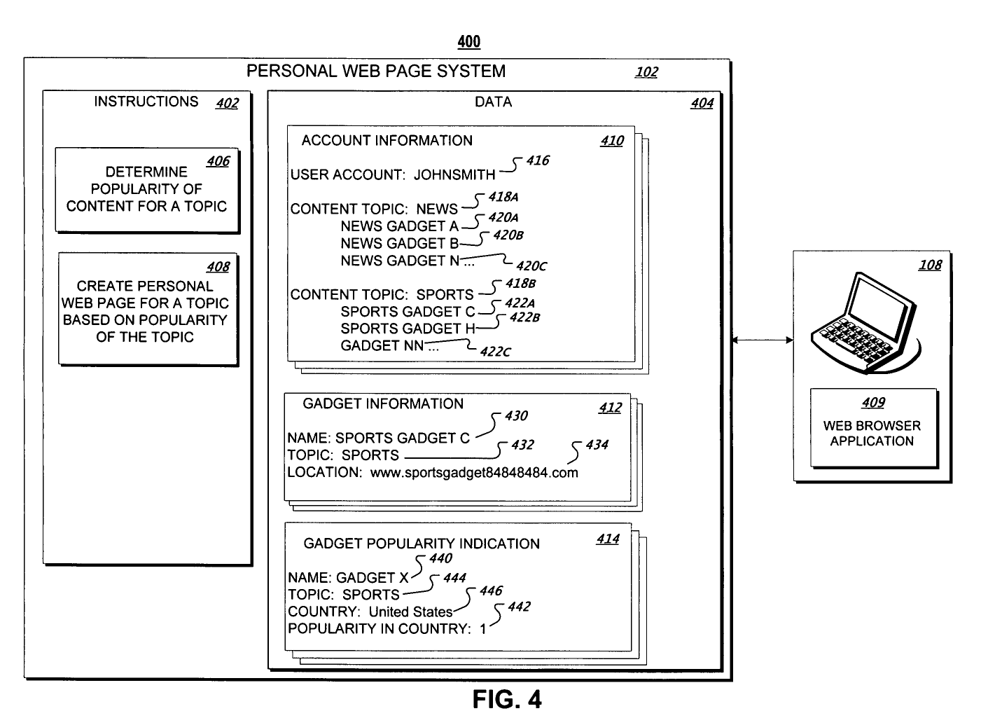

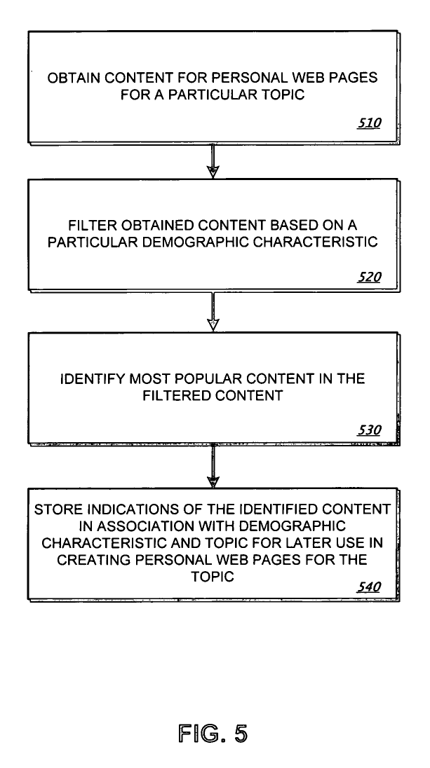

FIG. 4 illustrates an example environment 400 configured to provide personalized web pages. The environment 400 includes the personalized web page system 102 and the user access device 108, both discussed previously with respect to FIG. 1. The personalized web page system 102 includes processing instructions 402 and data 404. The processing instructions 402 include instructions 406 for determining the popularity of content for a topic and instructions 408 for creating a personalized web page for a topic based on popularity of the topic. The instructions 406 may be, for example, an implementation of process 500 described in more detail below with respect to FIG. 5. The instructions 408 may be an implementation of the process 300 previously discussed with respect to FIG. 3. The created web page can be presented on the user access device as part of a web browser application 409.

The data 404 included in the personalized web page system 102 includes account information 410, gadget information 412, and gadget popularity indications 414. The account information 410 may be stored in the user database 146, the gadget information 412 may be stored in the gadget database 136, and the gadget popularity indications 414 may be stored in the popularity database 126 as described previously with respect to FIG. 1.

The account information 410 includes, for each account, an account name 416 (here, “JOHNSMITH”, in the example information shown). The account information 410 also includes, for each account, a set of topics 418A (here, “NEWS”) and 418B (here, “SPORTS”) included on the personalized web page associated with the account. Each of the topics 418A and 418B may be associated with a set of gadgets. For example, the news topic 418A is associated with a “NEWS GADGET A” 420A gadget, a “NEWS GADGET B” 420B gadget, and a “NEWS GADGET N” 420C gadget. As another example, the sports topic 418B is associated with a “SPORTS GADGET C” 422A gadget, a “SPORTS GADGET H” 422B gadget, and a “GADGET NN” 422C gadget.

The gadget information 412 includes, for each gadget, a gadget name 430 (here, “SPORTS GADGET C”, in the example information shown), an associated topic 432 (here, “SPORTS”), and a gadget location 434 (here, “www.sportsgadget84848484.com”). The gadget name 430 can be displayed as a gadget title when the gadget is presented in a web page (e.g., as text displayed in the title of an area of a web page used to display the gadget). A gadget in the gadget information 412 may be referenced by (or otherwise linked to) user accounts in the account information 410. For example, the gadget name 430 of “SPORTS GADGET C” is included in the account information 410 as a gadget 422A associated with the topic 418A. The location 434 of a gadget may be a web address or URL (Uniform Resource Locator) associated with the gadget and may be used to receive content associated with the gadget. The location 434 may be associated with a publisher (e.g., publishers 104A-B) who provides the content for the gadget.

The gadget popularity indications 414 include, for each grouping of a gadget, topic, and demographic (e.g., country), an indication of the popularity of the gadget for the respective topic and country. For example, in the example data shown, a gadget 440 named “GADGET X” has a popularity index 442 of 1 for a topic 444 of “SPORTS” in the country 446 of the United States. The personalized web page system 102 can calculate the gadget popularity indications 414, such as described, for example, with respect to FIG. 5.

FIG. 5 shows an example process 500 for identifying popular content. The process 500 may be performed, for example, by the personalized web page system 102 discussed previously with respect to FIG. 1.

The process 500 includes obtaining content for personalized web pages for a particular topic (510). For example, the personalized web page system 102 may process existing personalized web pages stored for users (for example, personalized web pages stored in the user database 146) to search for personalized web page content (e.g. gadgets) that are related to a particular topic. The personalized web page system 102 may find content of a particular topic by searching for web page titles (e.g., tab names) that have the same name as the topic. For example, the personalized web page system 102 can determine that content included on a web page with a title (e.g., tab name) of “sports” is related to a topic of “sports”.

Once content related to a topic is obtained, obtained content is filtered based on a particular demographic characteristic (520). For example, obtained content may be filtered based on country, language, region, country, and/or another type of demographic or user characteristic. Obtained content can also be filtered based on group membership profiles. For example, users may belong to one or more groups (e.g., users may belong to one or more groups of friends, and users may also belong to one or more groups of users who share a common interest). Content can be filtered by group membership so that a user can be subsequently presented suggested, topic-oriented content that is used by other members of groups of which the user is a member.

The most popular content in the filtered content is identified ( 530). For example, the personalized web page system 102 may identify up to a specified or otherwise predetermined or user-entered number (e.g., 2, 3, 5, 10, etc.) of the most popular gadgets in the filtered content. The most popular gadgets may be identified according to a count of how many times a gadget appears in the filtered content. A threshold can be used to include only those gadgets who appear at least a certain number (e.g., 100, 1000, 10,000, etc.) of times in the filtered content.

Indications of the identified content are stored in association with the demographic characteristic and the topic for later use in creating personalized web pages for the topic (540). For example, the personalized web page system 102 may store indications of the identified content in the popularity database 126.

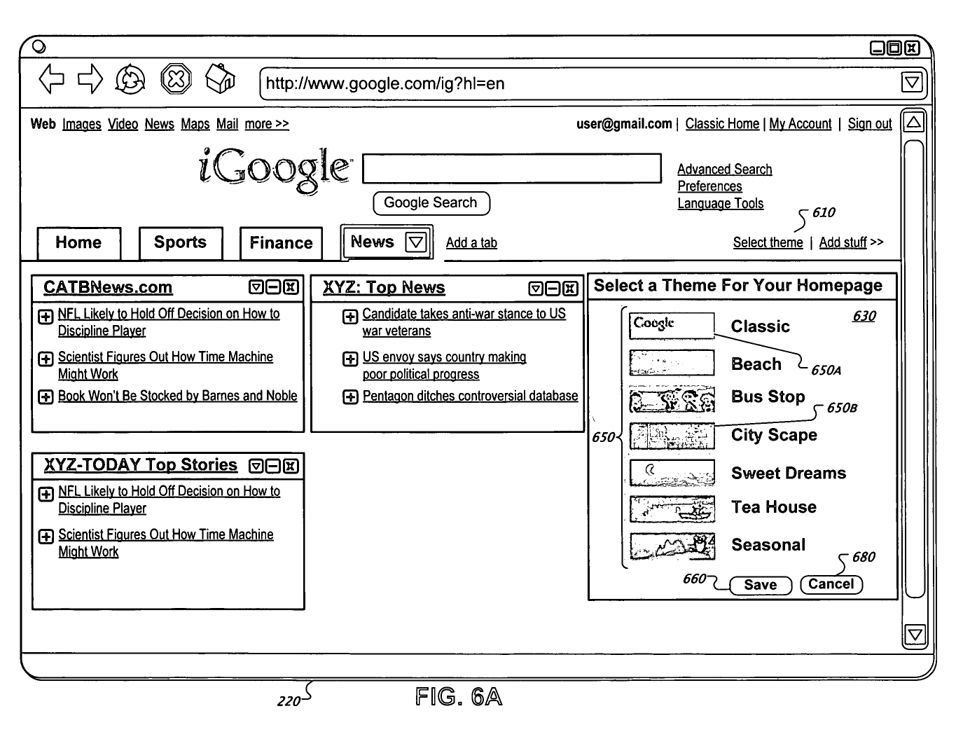

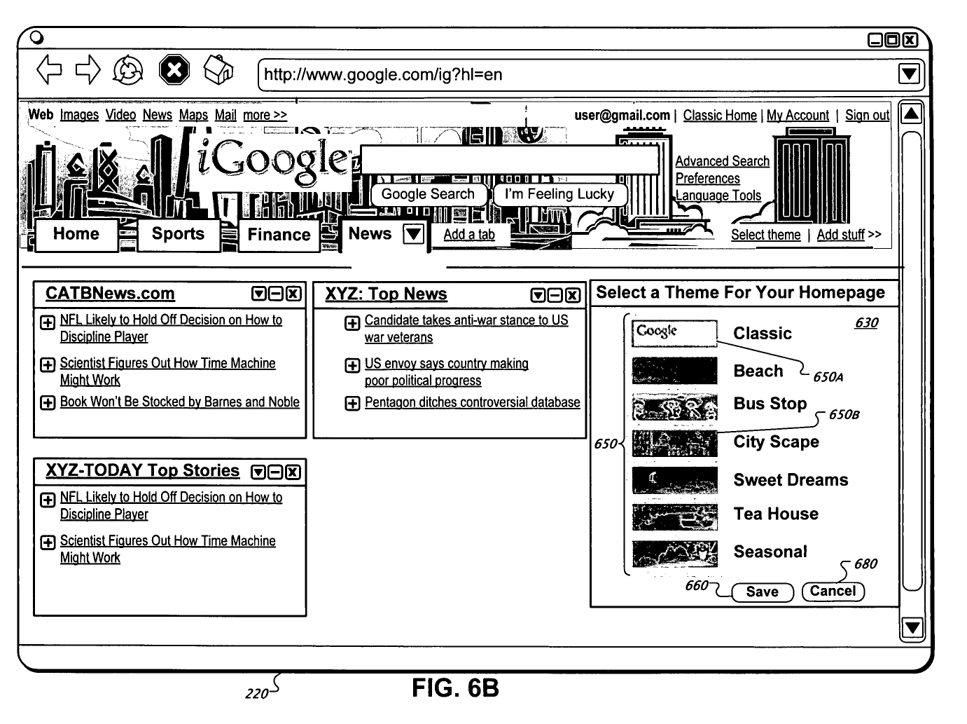

A popularity-driven selection mechanism can be applied in a variety of settings. In addition to a popularity-driven selection of web content for a personalized web page, a user can select a look-and-feel theme for a personalized web page from a set of popular themes (discussed in more detail below with respect to FIGS. 6A-B). Other look-and-feel options can be presented to the user in a popularity-driven manner. For example, a user may select how many columns to use to display gadgets (e.g., whether to display gadgets in two or three columns on the personalized web page 220). Choices for number of columns to use (e.g., 2, 3, etc.) can be determined based on the most popular column layouts used in existing personalized web pages. A default layout can also be determined based on most popular use.

FIGS. 6A and 6B illustrates example user interfaces for applying a theme to a personalized web page. Referring to FIG. 6A, a personalized web page 620 includes an area 630 for selecting a “look and feel” theme, or “skin.” The area 630 can be displayed, for example, in response to the selection of a “Select theme” link 640. The area 630 includes a set of graphical theme buttons 650, where each theme button shows a graphic illustrating the look and feel of a respective theme. For example, a “Classic” theme button 650A illustrates a simple theme and a “City Scape” theme button 650B illustrates a theme including graphics of city buildings. The user selects one of the theme buttons 650 to apply a respective theme. The displayed theme buttons can correspond to the most popular themes in use in personalized web pages associated with the personalized web page system 102.

The personalized web page 620 can be updated to reflect the applied theme, as will be discussed below. The user can select a “Save” button 660 to persistently save the theme selection so that the personalized web page 620 is displayed using the selected theme every time that the user accesses the page 620. An indication of the selected theme can be stored in association with the user in the user database 146. The area 630 can be removed from the personalized web page 620 after the theme selection has been saved. A “Cancel” button 670 can be selected to remove the area 630 from the personalized web page 620 without saving a theme.

FIG. 6B illustrates the personalized web page 620 with a theme applied. A “city landscape” theme has been applied to the personalized web page 620, in response to, for example, the selection of the theme button 650B. The user can display other themes by selecting a different one of the theme buttons 650. As discussed previously with respect to FIG. 6A, the user can select the “Save” button 660 to save the theme selection (and to remove the area 600 from the personalized web page 620), or the user can select the “Cancel” button 640 to remove the area 630 from the personalized web page 620 without saving a theme selection. Once the area 630 has been removed, gadgets that may have been hidden underneath (or otherwise removed from) the personalized web page 620 can be redisplayed. That is, gadgets on the right side of the web page 620 may have been hidden or removed in response to the display of the area 630, and the personalized web page 620 can be updated to redisplay these gadgets.

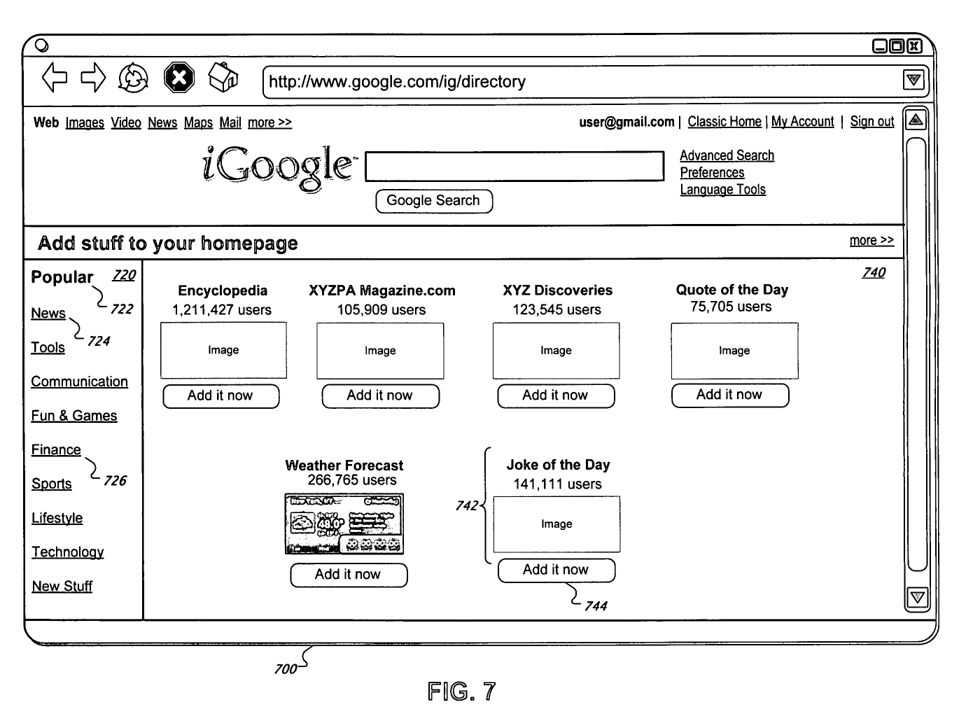

FIG. 7 illustrates an example web page 700 for selecting content for a personalized web page from a directory 720. The web page 700 can be displayed, for example, in response to the selection of the link 249 on the personalized web page 220 discussed previously with respect to FIG. 2B. The directory 720, which is included in the web page 700, includes a list of topic names. Here, a “Popular” topic 722 is the selected topic. The user can also select from among a list of other topics, including a “News” topic 724 and a “Finance” topic 726. The topics that are listed in the directory 720 can be determined (e.g., by the personalized web page system 102) based on topic popularity.

In response to the selection of a topic in the directory 720, information for gadgets associated with the selected topic is shown in an area 740 of the web page 700. For example, gadget information for popular gadgets is displayed, such as gadget information 742, which includes a gadget title (here, “Joke of the Day”), a popularity indication (e.g., “141,111 users”), and a graphic. The information displayed in the area 740 can be filtered by demographic, group affiliation or another type of user characteristic. For example, the area 740 can display gadgets associated with a user's language, country and/or region.

The gadget associated with the gadget information 742 can be added (e.g., to the personalized web page 720) by selecting a button 744. If the personalized web page 720 has an existing tab having the same name as the topic associated with the added gadget, then the added gadget can be placed on that tab. In some implementations, the added gadget is added to the tab that was displayed when the page 700 was launched. For example, with respect to FIG. 2D, the “News” tab 280 is the displayed tab. If the user selects the link 249 to launch the page 700, then gadgets added using the page 700 can be placed on the “News” tab 280. In other implementations, added gadgets are added to the user's “Home” tab.

On the page 700, gadget information for the most popular gadgets in other topic areas can be displayed in the area 740 by selecting a different topic in the directory 720. For example, the area 740 can display information about the most popular finance gadgets in response to the selection of the “Finance” topic 726.

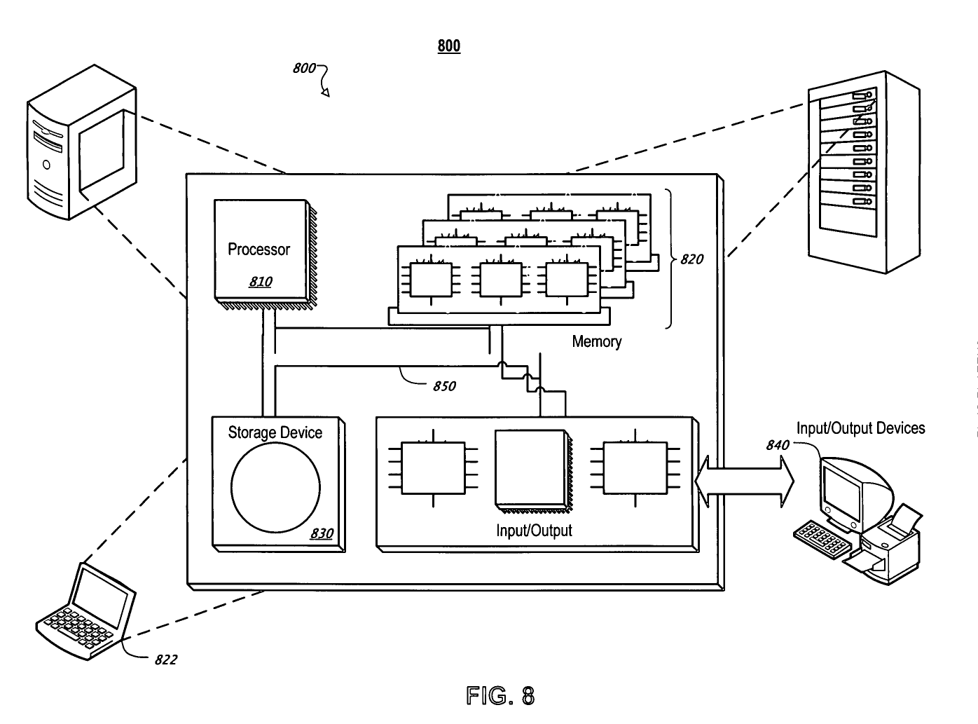

FIG. 8 is a block diagram of a system 800 for performing the various operations described in reference to FIGS. 1-7. For example, the system 800 may be included in the personalized web page system 102, the publisher 104A, and/or the publisher 104B, described in reference to FIG. 1. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In some implementations, the processor 810 is a single-threaded processor. In other implementations, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. In other implementations, the memory 820 is a volatile memory unit. In yet other implementations, the memory 820 is a non-volatile memory unit.

The storage device 830 is capable of providing mass storage for the system 800. In some implementations, the storage device 830 is a computer-readable medium. In various different implementations, the storage device 830 may be a floppy disk device, a hard disk device, an optical disk device, or a tape device.

The input/output device 840 provides input/output operations for the system 800. In some implementations, the input/output device 840 includes a keyboard and/or pointing device. In other implementations, the input/output device 840 includes a display unit for displaying graphical user interfaces.

The disclosed and other implementations and the functional operations described in this description can be implemented in digital electronic circuitry, or in computer software, firmware, or hardware, including the structures disclosed in this specification and their structural equivalents, or in combinations of one or more of them. The disclosed and other implementations can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this description can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the disclosed techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed techniques can be implemented in a computing system that includes a back end component, e.g., as a data server, or that includes a middleware component, e.g., an application server, or that includes a front end component, e.g., a client computer having a graphical user interface or a Web browser through which a user can interact with an implementation of what is disclosed here, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this description contains many specifics, these should not be construed as limitations on the scope of what is being claimed or of what may be claimed, but rather as descriptions of features specific to particular implementations. For example, entering a navigation tab title or name has been identified as a way to identify a topic for a personalized web page, though other methods may be used.

Certain features that are described in this description in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The techniques and concepts have been generally described with respect to customizing web pages. The techniques and concepts may be applied to other types of electronic networked documents.

Thus, particular implementations have been described. Other implementations are within the scope of the following claims.

1. A computer-implemented method, comprising:
receiving (i) data indicating a user request to create a web page element for a personalized web page of a user and (ii) data indicating a name specified by the user for the web page element to be created for the personalized web page of the user;
identifying other users that are members of a group of which the user is also a member;
identifying gadgets that are identified as relevant to a topic associated with the name;
determining a frequency with which each gadget that is identified as relevant to the topic associated with the name has been included in web page elements on personalized web pages of the other users that are members of a group of which the user is also a member; and
selecting a subset of the gadgets based on the frequency with which each gadget that is identified as relevant to the topic associated with the name has been included in web page elements on the personalized web pages of the other users that are members of a group of which the user is also a member.

2-43. (canceled)

44. The method of claim 1, wherein identifying gadgets that are identified as relevant to a topic associated with the name comprises:
identifying a particular topic based, at least in part, on the name;
associating the name with the particular topic; and
identifying gadgets related to the particular topic.

45. The method of claim 1, wherein receiving data indicating a name specified by the user for the web page element comprises receiving data indicating a name for the web page element based, at least in part, on a control used to navigate to the web page element.

46. The method of claim 1, wherein the other users that are members of a group of which the user is also a member share one or more demographic characteristics with the user.

47. The method of claim 46, wherein the one or more demographic characteristics comprise at least one of a country or a language.

48. The method of claim 1, wherein the gadgets that are identified as relevant to a topic associated with the name include automatically updated gadgets.

49. The method of claim 48, wherein the automatically updated gadgets comprise a Rich Site Summary (RSS) feed.

50. The method of claim 1, further comprising automatically selecting, based on a popularity of a theme according to the other users that are members of a group of which the user is also a member, a theme for the web page element.

51. The method of claim 1, further comprising automatically selecting, based on a popularity of a layout style for a personalized web page element, a layout style for the web page element.

52. The method of claim 1, further comprising automatically providing to the user a recommendation of at least one new gadget for the web page element based on a popularity of the gadgets that are identified as relevant to a topic associated with the name, according to the other users that are members of a group of which the user is also a member.

53. The method of claim 1, further comprising automatically providing a representation of one or more gadgets of the selected subset of the gadgets for inclusion in the web page element on the user's personalized web page.

54. A system comprising:
one or more computers and one or more storage devices storing instructions that are operable, when executed by the one or more computers, to cause the one or more computers to perform operations comprising:
receiving (i) data indicating a user request to create a web page element for a personalized web page of a user and (ii) data indicating a name specified by the user for the web page element to be created for the personalized web page of the user;
identifying other users that are members of a group of which the user is also a member;
identifying gadgets that are identified as relevant to a topic associated with the name;
determining a frequency with which each gadget that is identified as relevant to the topic associated with the name has been included in web page elements on personalized web pages of the other users that are members of a group of which the user is also a member; and
selecting a subset of the gadgets based on the frequency with which each gadget that is identified as relevant to the topic associated with the name has been included in web page elements on the personalized web pages of the other users that are members of a group of which the user is also a member.

55. The system of claim 54, wherein identifying gadgets that are identified as relevant to a topic associated with the name comprises:
identifying a particular topic based, at least in part, on the name;
associating the name with the particular topic; and
identifying gadgets related to the particular topic.

56. The system of claim 54, wherein receiving data indicating a name specified by the user for the web page element comprises receiving data indicating a name for the web page element based, at least in part, on a control used to navigate to the web page element.

57. The system of claim 54, wherein the other users that are members of a group of which the user is also a member share one or more demographic characteristics with the user.

58. The system of claim 57, wherein the demographic characteristics comprise at least one of a country or a language.

59. The system of claim 54, wherein the gadgets that are identified as relevant to a topic associated with the name include automatically updated gadgets.

60. The system of claim 59, wherein the automatically updated gadgets comprise a Rich Site Summary (RSS) feed.

61. The system of claim 54, further comprising operations of automatically selecting, based on a popularity of a theme according to the other users that are members of a group of which the user is also a member, a theme for the web page element.

62. The system of claim 54, further comprising operations of automatically selecting, based on a popularity of a layout style for a personalized web page element, a layout style for the web page element.

63. The system of claim 54, further comprising operations of automatically providing to the user a recommendation of at least one new gadget for the web page element based on a popularity of the gadgets that are identified as relevant to a topic associated with the name, according to the other users that are members of a group of which the user is also a member.

64. The system of claim 54, further comprising operations of automatically providing a representation of one or more gadgets of the selected subset of the gadgets for inclusion in the web page element on the user's personalized web page.

65. A non-transitory computer-readable medium storing software comprising instructions executable by one or more computers which, upon such execution, cause the one or more computers to perform operations comprising:
receiving (i) data indicating a user request to create a web page element for a personalized web page of a user and (ii) data indicating a name specified by the user for the web page element to be created for the personalized web page of the user;
identifying other users that are members of a group of which the user is also a member;
identifying gadgets that are identified as relevant to a topic associated with the name;
determining a frequency with which each gadget that is identified as relevant to the topic associated with the name has been included in web page elements on personalized web pages of the other users that are members of a group of which the user is also a member; and
selecting a subset of the gadgets based on the frequency with which each gadget that is identified as relevant to the topic associated with the name has been included in web page elements on the personalized web pages of the other users that are members of a group of which the user is also a member.
